(19) United States
(12) Patent Application Publication
(10) Pub. No.: US 2017/0124249 A1
(43) Pub. Date: May 4, 2017

(54) HIGH-SPEED PLATFORM MOTION PARAMETER SELF-TUNING METHOD BASED ON MODEL IDENTIFICATION AND EQUIVALENT SIMPLIFICATION

(71) Applicant: GUANGDONG UNIVERSITY OF TECHNOLOGY, Guangzhou (CN)

(72) Inventors: Zhijun Yang, Guangzhou (CN); Youdun Bai, Guangzhou (CN); Xin Chen, Guangzhou (CN); Jian Gao, Guangzhou (CN); Xindu Chen, Guangzhou (CN); Yunbo He, Guangzhou (CN); Yun Chen, Guangzhou (CN); Chengxiang Li, Guangzhou (CN); Jianglong Wang, Guangzhou (CN)

(73) Assignee: GUANGDONG UNIVERSITY OF TECHNOLOGY

(21) Appl. No.: 15/375,174

(22) Filed: Dec. 12, 2016

Related U.S. Application Data
(63) Continuation of application No. PCT/CN2015/095407, filed on Nov. 24, 2015.

(30) Foreign Application Priority Data
Jun. 8, 2015 (CN) 201510312646.8

(51) Int. Cl. G06F 17/50

(52) U.S. Cl. CPC G06F 17/5086

(57) ABSTRACT

A high-speed platform motion parameter self-tuning method based on model identification and equivalent simplification is provided, comprising: establishing a test of a motion state of a high-speed platform, identifying model parameters, and optimizing motion parameters of an equivalent simplified model; selecting any motion function from a pre-set parameterized curve, setting initial parameters, and driving the high-speed platform to move under the action of a controller and an actuator; collecting dynamic response information of the platform, calculating dynamic characteristic information of the platform such as stiffness, frequency, damping and the like; establishing a dynamic response equivalent simplified model by using the acquired dynamic characteristic information, and performing the optimization constrained by meeting motion precision and targeting at shorter execution time for the motion parameters in the selected parameterized motion function to obtain the optimum parameters. The method of the present invention gives consideration to the dynamic characteristic requirement of the platform and the comprehensive requirement of the parameter identification and optimization on the industrial site, facilitates the implementation of an algorithm in a motion control card, and is suitable for rapidly acquiring the optimum motion parameters of the actual high-speed platform on site.

### CROSS-REFERENCE TO RELATED APPLICATIONS

This application is a continuation of International Patent Application No. PCT/CN2015/095407 with a filing date of Nov. 24, 2015, designating the United States, now pending, and further claims priority to Chinese Patent Application No. 201510312646.8 with a filing date of Jun. 8, 2015. The content of the aforementioned application, including any intervening amendments thereto, are incorporated herein by reference.

### TECHNICAL FIELD

The present invention relates to the technical field of mechanical engineering, automatic control and mathematical study, and particularly relates to a high-speed platform motion parameter self-tuning method based on model identification and equivalent simplification.

### BACKGROUND OF THE PRESENT INVENTION

The precise movement of a high-speed platform mainly involves in two indexes, i.e. motion velocity and motion precision, wherein with regard to the high-speed platform, when the motion velocity reaches a given level, the elastic vibration of the platform cannot be ignored, i.e. when the platform shows the “flexibility” characteristic, after an appropriate motion curve is selected, the selection of the parameter influences an excitation spectrum; however, the parameters are mainly tuned according to artificial experience at present, which not only wastes time, but also is restricted by the experience.

The intrinsic dynamic physical laws of the platform are difficult to consider in a conventional self-adaptive control solution, which usually leads to a feasible self-adaptive result rather than an optimum self-adaptive result. In addition, the implementation process of the self-adaptive control solution is relatively sophisticated, so the self-adaptive control solution may not be suitable for the high-frequency response application field such as IC encapsulation, and the application range of the self-adaptive control solution is limited.

An S-type motion curve planning method for reducing residual vibration of a high-speed platform is disclosed in patent 201310460878.9, which establishes a flexible multi-body dynamic model based on high-precision truncation modal superposition, and forms a comprehensive optimized model in combination with a parameterized S-type motion function; and the patent is mainly used for the planning of the S-type motion curve, the multi-body dynamic response model based on the modal truncation established in the solution of the patent ignores the influence of the high-order mode, and the solution of the patent is only suitable for the field where the velocity is not too high. In addition, the patent involves the application of the multi-body dynamic simulation software which is mainly used for the off-line optimization and cannot meet the requirement for rapidly self-tuning the parameters on site.

An asymmetric variable acceleration planning method based on optimum distribution of main frequency energy time domain is provided in the patent 201410255068.4. The problem for planning the motion with the optimum time under the nonlinear influence of the high-speed and high-acceleration platform such as the large flexible deformation is solved by using the structural finite element model with the kinematics degree of freedom and the comprehensive optimization of the parameterized motion function. A major characteristic of the patent is to acquire the dynamic response of the platform under a nonlinear working condition by using the finite element dynamic simulation technology, the modal truncation error of a dynamic substructure is avoided, and the dynamic substructure is comprehensively optimized in combination with the parameter motion function, thereby acquiring the optimum parameter value of the motion function targeting at the shortest time, and being applied to the engineering practice. However, since the nonlinear finite element model is used as the dynamic response model used in the optimization process, the calculation complexity is relatively high, the nonlinear finite element model can only be used at the design optimization stage and cannot be used for the optimization and parameter tuning at the industrial site. In addition, due to the error, caused by the processing and manufacturing, between the finite element model and the actual platform, the optimization result can be ensured to be feasible by means of test and model correction.

### SUMMARY OF PRESENT INVENTION

An objective of the present invention is to provide a high-speed platform motion parameter self-tuning method based on model identification and equivalent simplification, which is used for rapidly acquiring optimum motion parameters of an actual high-speed platform on site and avoiding the defects in the existing method; and the method proposed by the present invention can also be integrated in a real controller.

In order to achieve the objective, the present invention adopts a technical solution as follows:

The high-speed platform motion parameter self-tuning method based on the model identification and equivalent simplification is characterized by comprising the following steps:
step I, a motion function is selected from pre-set parameterized motion functions, initial parameters are set, and a high-speed platform is driven to move under the action of a controller and an actuator;
step II, motion state information of the platform is collected, and dynamic characteristic information of the platform is acquired;
step III, an equivalent single-degree-of-freedom dynamic response model with reference to a driving direction is established by using the dynamic characteristic information obtained in step II, stiffness, inertia, frequency and damping parameters of the equivalent model are identified, and an equivalent modal dynamic response model corresponding to the dynamic response of an actual platform is established; and
step IV, the comprehensive optimization meeting the motion precision and having shorter execution period is carried out on the motion parameters in the parameterized motion function selected in step I according to the equivalent modal dynamic response model of the step III.

Still further, the step III specifically comprises the following steps:
A, double acceleration sensors, respectively disposed at a working end and a guide rail end, which can measure a stiffness motion acceleration and an elastic vibration acceleration are arranged, the velocity and displacement information is obtained by integration, and frequency of the elastic vibration is obtained through Fourier transform;
B, a driving force is calculated by the current of the actuator, an equivalent load causing the elastic deformation is calculated by the difference between the driving force and an inertia force (through a product of a platform mass and the stiffness motion acceleration), the elastic deformation is calculated by a difference between the stiffness displacement obtained in A and the total displacement, a quotient of the stiffness displacement and the total displacement is equivalent stiffness, and the equivalent inertia is calculated according to the elastic frequency;
C, elastic amplitudes are fit to obtain a displacement attenuation index when the driving is stopped, and the equivalent damping is calculated according to the stiffness, the inertia and the frequency; and
D, the platform is equivalent to a single-degree-of-freedom mass spring damping system, and an equivalent simplified model is established by adopting the acquired parameters.

Still further, the step IV specifically comprises two optional solutions:
1) the parameter optimization based on the actual driving operation comprises the following steps:
1a, the platform is driven to move by taking the parameterized curve as the motion function, and a vibration and locating time is measured;
1b, minor modification is gradually carried out on the parameters one by one, the locating time is obtained by virtue of operation measurement, and the sensitivity of each parameter is calculated;
1c, a search step length is calculated according to the equivalent model, the parameters are updated, the locating time is re-measured; and
1d, the steps 1b and 1c are repeated until the shortest locating time is obtained.
2) the parameter optimization based on the equivalent model simulation comprises the following steps:
2a, the model simulation is carried out by taking the parameterized motion function as a boundary condition, and the vibration and locating time is measured;
2b, the minor modification is gradually carried out on the parameters one by one, the locating time is obtained by performing the simulation, and the sensitivity of each parameter is calculated;

2c, the search step length is calculated according to the equivalent model, the parameters are updated, and the locating time is obtained by re-simulation; and
2d, the steps 2b and 2c are repeated until the shortest location time is obtained.

Still further, in the step II, the dynamic response information of the platform is collected by an acceleration vibration meter.

Still further, the self-tuning method is integrated in the controller.

The present invention has the beneficial effects: 1, the sophisticated multi-body dynamic response model is converted to the simplified equivalent dynamic response model by using the dynamic response equivalent method, so that the method proposed by the present invention can be integrated in the controller, and the in-situ rapid optimization and self-tuning of the motion parameters can be realized; and 2, the modal shape in the obtained equivalent dynamic response model is an expected motion degree of freedom of the platform, thereby guaranteeing the consistent effectiveness of the motion parameter optimization result.

### DESCRIPTION OF THE DRAWINGS

FIG. 1 is an overall implementation route chart of an embodiment of the present invention.

FIG. 2 is a flow chart of model identification of an embodiment of the present invention.

FIG. 3 is a flow chart based on physical motion parameter of an embodiment of the present invention.

FIG. 4 is a flow chart of parameter self-tuning based on the equivalent model simulation of an embodiment of the present invention.

### DETAILED DESCRIPTION OF PREFERRED EMBODIMENTS

The technical solution of the present invention is further described below in combination with drawings through specific embodiments.

A high-speed platform motion parameter self-tuning method based on model identification and equivalent simplification is provided, comprising the following steps:
step I, a motion function is selected from pre-set parameterized motion functions, initial parameters are set, and a high-speed platform is driven to move under the action of a controller and an actuator;
step II, motion state information of the platform is collected, and dynamic characteristic information of the platform is acquired;
step III, an equivalent single-degree-of-freedom dynamic response model with reference to a driving direction by using the dynamic characteristic information obtained in step II is established, stiffness, inertia, frequency and damping parameters of the equivalent model are identified, and an equivalent modal dynamic response model corresponding to the dynamic response of an actual platform is established; and
step IV, the comprehensive optimization meeting the motion precision and having shorter execution period is carried out on the motion parameters in the parameterized motion function selected in step I according to the equivalent modal dynamic response model of the step III.

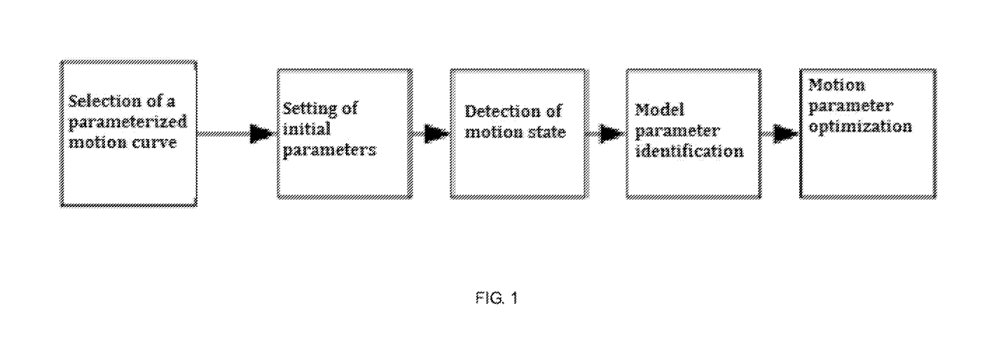

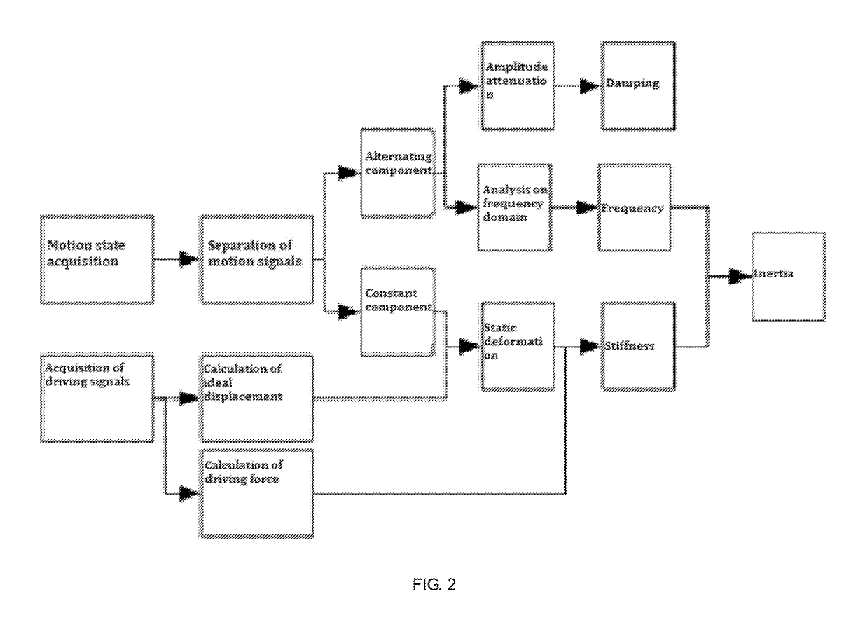

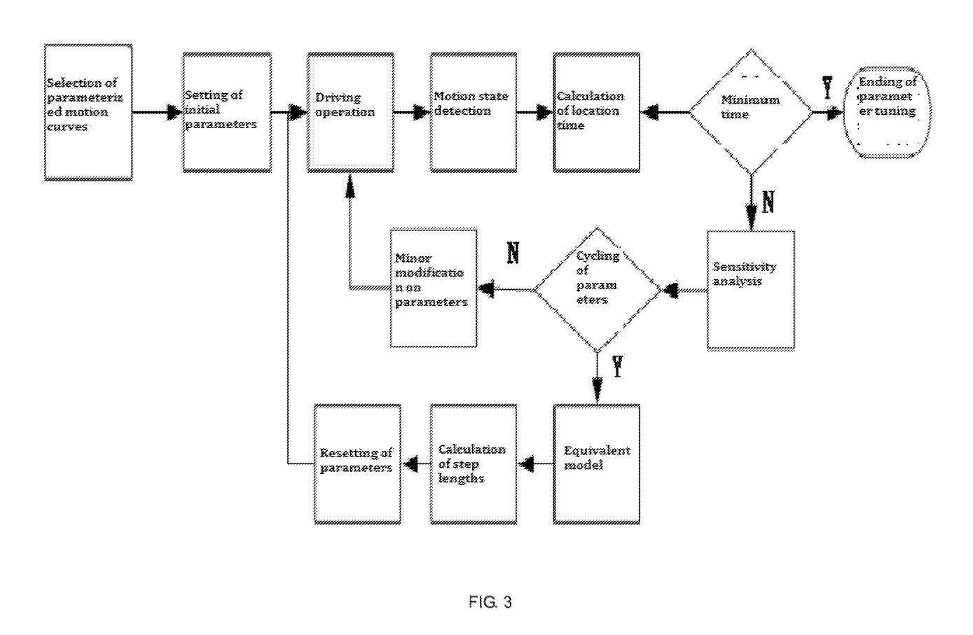

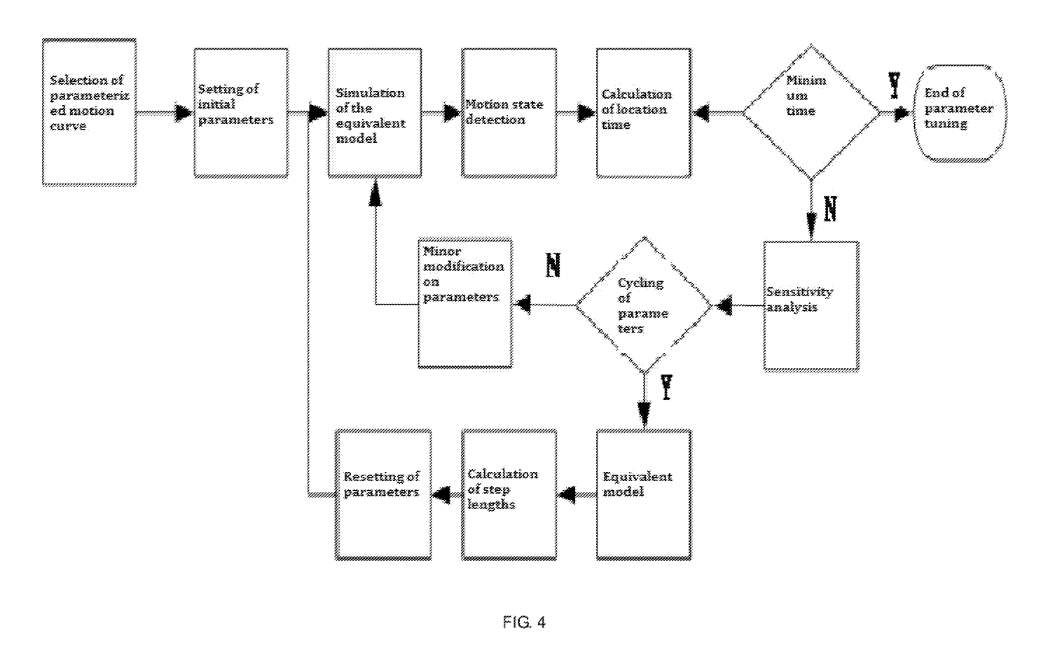

In combination with FIG. 1-FIG. 4, the self-tuning method of the present invention solves the problems in the prior art that: a dynamic model is needed in the optimization process, a controlled object is required to be modeled, tested and model-corrected so as to guarantee the accuracy of the model; on the other hand, the optimization process depends on expensive commercial software such as multi-body dynamic or nonlinear finite elements; and finally the calculation amount for optimizing the model is large and optimization cannot be realized in a control card.

The equivalent multi-body dynamic response model with the modal shape consistent with the expected motion degree of freedom is applied, the consistent equivalent relationship between the equivalent dynamic response model and the actual platform model is sufficiently considered, and the effectiveness of the optimization result is guaranteed. Secondly, the calculation amount of the equivalent dynamic response model in the method of the present invention is relatively small, the equivalent multi-body dynamic response model of the actual platform system can be rapidly re-constructed at an industrial site, the parameters can be rapidly self-tuned, and the incompatibility problem of the optimum parameter caused by an error between an ideal model at the design stage and the actual platform can be avoided. Compared with the traditional parameter process optimization method based on the experimental design analysis and the method by purely using the finite model, the present invention gives consideration both to the comprehensive requirement for the precise model building optimization and the industrial-site parameter identification optimization.

Still further the step III specifically comprises the following steps:
A, double acceleration sensors, respectively disposed at a working end and a guide rail end, which can measure a stiffness motion acceleration and an elasticity vibration acceleration are arranged, the velocity and displacement information is obtained by integral, and the frequency of the elastic vibration is obtained through Fourier transform;
B, a driving force is calculated by the current of the actuator, an equivalent load causing the elastic deformation is calculated by the difference between the driving force and an inertia force (through a product of a platform mass and the stiffness motion acceleration), the elastic deformation is calculated by a difference between the stiffness displacement obtained in A and the total displacement, a quotient of the stiffness displacement and the total displacement is equivalent stiffness, and the equivalent inertia is calculated according to the elastic frequency;
C, elastic amplitudes are fit to obtain a displacement attenuation index when the driving is stopped, and the equivalent damping is calculated according to the stiffness, the inertia and the frequency; and
D, the platform is equivalent to a single-degree-of-freedom mass spring damping system, and an equivalent simplified model is established by adopting the acquired parameters.

Still further, the step IV specifically comprises two optional solutions:
1) the parameter optimization based on the actual driving operation comprises the following steps:
1a, the platform is driven to move by taking the parameterized curve as the motion function, and the vibration and locating time is measured;
1b, the minor modification is gradually carried out on the parameters one by one, the locating time is obtained by virtue of operation measurement, and the sensitivity of each parameter is calculated;
1c, a search step length is calculated according to the equivalent model, the parameters are updated, the locating time is remeasured; and
1d, the steps 1b and 1c are repeated until the shortest location time is obtained;
2) the parameter optimization based on the equivalent model simulation comprises the following steps:
2a, the model simulation is carried out by taking the parameterized motion function as a boundary condition, and the vibration and locating time is measured;
2b, the minor modification is gradually carried out on the parameters one by one, the locating time is obtained by performing the simulation, and the sensitivity of each parameter is calculated;
2c, the search step length is calculated according to the equivalent model, the parameters are updated, and the locating time is obtained by re-simulation; and
2d, the steps 2b and 2c are repeated until the shortest locating time is obtained.

Still further, in the step II, the dynamic response information of the platform is collected by an acceleration vibration meter.

Still further, the self-tuning method is integrated in the controller. The self-tuning method can be integrated in the controller, thereby achieving the rapid in-situ optimization and self-tuning of the motion parameters.

Embodiment I-Model Parameter Identification

The driving force and the vibration response in a main direction are tested, the static deformation and the dynamic response are separated by analyzing signals, the stiffness is the driving force/static deformation, the frequency of the dynamic response is acquired through the Fourier transform, and the equivalent inertia is calculated according to a frequency formula. Finally, a damping ratio is calculated in a fitting manner according to an attenuation relation of adjacent amplitudes.

Optimization Solution 1: (Numerical Optimization)

The equivalent stiffness mass damping model is structured, the numerical calculation is carried out on the selected parameterized model, the parameter variation is predicted, the model parameter is corrected according to an actual test, and the optimization is carried out by adopting the equivalent model to obtain the optimum parameter curve.

Solution 2:

The motion parameters are gradually modified with minor variation one by one; pilot run is carried out, and the response time after the parameters are changed is measured; a sensitivity gradient is calculated; the parameter search step length is estimated by taking the equivalent model as a nominal model; and the sensitivity gradient calculation and step length estimation process is repeated until an optimum solution is obtained.

The technical principle of the present invention is described above in combination with specific embodiments. The description is only used to explain the principle of the present invention, rather than limiting the protection scope of the present invention in any form. Based on the explanation herein, other specific implementation ways of the present invention can be conceived by those skilled in the art without making creative effort, while these implementation ways fall within the protection scope of the present invention.

We claim:

1. A high-speed platform motion parameter self-tuning method based on model identification and equivalent simplification, characterized by comprising the following steps:
step I, selecting a motion function from pre-set parameterized motion functions, setting initial parameters, and driving a high-speed platform to move under the action of a controller and an actuator;
step II, collecting motion state information of the platform, and acquiring dynamic characteristic information of the platform;
step III, establishing an equivalent single-degree-of-freedom dynamic response model with reference to a driving direction by using the dynamic characteristic information obtained in step II, identifying stiffness, inertia, frequency and damping parameters of the equivalent model, and building an equivalent modal dynamic response model corresponding to the dynamic response of an actual platform; and
step IV, performing the comprehensive optimization meeting the motion precision and having shorter execution period for the motion parameters in the parameterized motion function selected in step I according to the equivalent modal dynamic response model of step III.

2. The high-speed platform motion parameter self-tuning method based on the model identification and equivalent simplification according to claim 1, characterized in that: the step III specifically comprises the following steps:
A, arranging double acceleration sensors, respectively disposed at a working end and a guide rail end, which can measure a stiffness motion acceleration and an elastic vibration acceleration, integrating the velocity and displacement information, and obtaining frequency of the elastic vibration through Fourier transform;
B, calculating a driving force by the current of the actuator, calculating an equivalent load causing the elastic deformation by a difference between the driving force and an inertial force (a product of a platform mass and the stiffness motion acceleration), calculating the elastic deformation by the difference between the stiffness displacement and a total displacement obtained in A, wherein a quotient between the stiffness displacement and the total displacement is the equivalent stiffness, and calculating equivalent inertia according to the elastic frequency;
C, fitting elastic amplitudes when the driving is stopped, obtaining a displacement attenuation index, and calculating equivalent damping according to the stiffness, the inertia and the frequency; and
D, the platform being equivalent to a single-degree-of-freedom mass spring damping system, and establishing an equivalent simplified model according to the acquired parameters.

3. The high-speed platform motion parameter self-tuning method based on the model identification and equivalent simplification according to claim 1, characterized in that: the step IV specifically comprises two optional solutions:
1) the parameter optimization based on the actual driving operation comprises the following steps:
1a, taking a parameterized curve as a motion function, driving the platform to move, and measuring vibration and location time;
1b, gradually performing minor modification on the parameters one by one, obtaining locating time by virtue of operation measurement, and calculating sensitivity of each parameter;
1c, calculating a search step length according to the equivalent model, updating the parameters, re-operating, and measuring the locating time; and
1d, repeating the steps 1b and 1c until a shortest location time is obtained.
2) the parameter optimization based on the equivalent model simulation comprises the following steps:
2a, taking the parameterized motion function as a boundary condition, performing the model simulation, and measuring the vibration and locating time;
2b, gradually performing minor modification on the parameters one by one, obtaining the locating time by virtue of simulation, and calculating sensitivity of each parameter;
2c, calculating the search step length according to the equivalent model, updating the parameters, and re-simulating the model to obtain the locating time; and
2d, repeating the steps 2b and 2c until the shortest locating time is obtained.

4. The high-speed platform motion parameter self-tuning method based on the model identification and equivalent simplification according to claim 1, characterized in that: in the step II, the dynamic response information of the platform is connected by an acceleration vibration meter.

5. The high-speed platform motion parameter self-tuning method based on the model identification and equivalent simplification according to claim 1, characterized in that: the self-tuning method is integrated in the controller.

6. The high-speed platform motion parameter self-tuning method based on the model identification and equivalent simplification according to claim 2, characterized in that: the step IV specifically comprises two optional solutions:
1) the parameter optimization based on the actual driving operation comprises the following steps:
1a, taking a parameterized curve as a motion function, driving the platform to move, and measuring vibration and location time;
1b, gradually performing minor modification on the parameters one by one, obtaining locating time by virtue of operation measurement, and calculating sensitivity of each parameter;
1c, calculating a search step length according to the equivalent model, updating the parameters, re-operating, and measuring the locating time; and
1d, repeating the steps 1b and 1c until a shortest location time is obtained.
2) the parameter optimization based on the equivalent model simulation comprises the following steps:
2a, taking the parameterized motion function as a boundary condition, performing the model simulation, and measuring the vibration and locating time;
2b, gradually performing minor modification on the parameters one by one, obtaining the locating time by virtue of simulation, and calculating sensitivity of each parameter;
2c, calculating the search step length according to the equivalent model, updating the parameters, and re-simulating the model to obtain the locating time; and
2d, repeating the steps 2b and 2c until the shortest locating time is obtained.
